(19) United States
(12) Patent Application Publication
(10) Pub. No.: US 2015/0345978 A1
(43) Pub. Date: Dec. 3, 2015

(54) NAVIGATIONAL COMPUTER SYSTEM AND METHOD FOR PRESENTING LOCAL SEARCH DATA

(71) Applicant: SPRYLOGICS INTERNATIONAL CORP., Vaughan (CA)

(72) Inventors: Marvin IGELMAN, Thornhill (CA); Aleksandar ZIVKOVIC, North York (CA)

(21) Appl. No.: 14/718,722

(22) Filed: May 21, 2015

Related U.S. Application Data
(60) Provisional application No. 62/001,294, filed on May 21, 2014.

(51) Int. Cl. G01C 21/36

(52) U.S. Cl. CPC G01C 21/3605

(57) ABSTRACT

A navigational computer system and method are provided for presenting local search data according to travel time to points of interest. The navigational computer system comprises a selection engine in communication with a database of points of interest. In response to a user request for a list of points of interest from within a class or type of points of interest, the selection engine is configured to identify and rank points of interest from amongst the class according to estimated travel times for the user to those points of interest. A user equipped with a mobile device or other user interface unit may select search parameters which are provided to the selection engine as a search query. The selection engine provides a list in ranked order of suitable points of interest to the user interface unit. The navigational computer system and method allow a user to search for points of interest based on estimated travel time to those points of interest.

### TECHNICAL FIELD

The following is generally directed to navigational computer systems and more specifically to a navigational computer system and method configured to present local search data according to travel times to local search results.

### BACKGROUND

Many mobile devices include hardware enabling them to be used as navigational devices. Additionally, standalone navigational devices exist.

Location based search applications are often used on these devices to search for points of interest. Examples of points of interest include restaurants, theatres, retail stores, automotive service centres, parks, vehicle parking lots, etc. The results are often presented as a list or a map on the device.

### SUMMARY

In embodiments, a navigational computer system and method is provided which presents a list of candidate locations in order of estimated travel times from a starting location to each of the candidate locations. In one aspect, the navigational computer system enables a user to identify which candidate locations from amongst a requested class of candidate locations are nearest to the user in terms of estimated travel time.

In embodiments, a navigational computer system is provided for presenting local search data to a user using a user interface unit according to travel time to a plurality of candidate locations. The navigational computer system may comprise: a candidate locations database storing a plurality of candidate locations; and a selection engine in communication with the candidate locations database, a routing engine and a user interface unit. The selection engine may be configured to: obtain from the user interface unit a search query for a class of candidate locations; identify in the candidate locations database a plurality of candidate locations belonging to the class; request and obtain from the routing engine an estimated travel time for the user from a starting location to each of the identified plurality of candidate locations belonging to the class; rank the identified plurality of candidate locations according to the estimated travel time to each of the identified plurality of candidate locations; and provide to the user interface unit a list of the identified plurality of candidate locations ordered according to the ranking.

In further embodiments, a navigational computer method is provided for presenting local search data to a user using a user interface unit according to travel time to a plurality of candidate locations. The navigational computer method may comprise: a selection engine obtaining from the user interface unit a search query for a class of candidate locations; the selection engine identifying in a candidate locations database a plurality of candidate locations from the class; the selection engine requesting and obtaining from a routing engine an estimated travel time for the user to each of the identified plurality of candidate locations from a starting location; the selection engine ranking the identified plurality of candidate locations according to the estimated travel time to each of the identified plurality of candidate locations; and the selection engine providing to the user interface unit a list of the identified plurality of candidate locations ordered according to the ranking.

These and other embodiments are contemplated, and described herein.

### BRIEF DESCRIPTION OF THE DRAWINGS

Embodiments will now be described by way of example only with reference to the appended drawings wherein:

FIG. 1 is an architecture diagram of a navigational computer system for presenting local search data; and

FIG. 2 is a flowchart depicting a navigational computer method for presenting local search data.

### DESCRIPTION

Embodiments will now be described with reference to the figures. It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It will be appreciated that various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

Any module, unit, engine, component, server, computer, terminal or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application or module herein described may be implemented using computer readable/executable instructions that may be stored or otherwise held by such computer readable media and executed by the one or more processors.

A navigational computer system and method are provided for presenting local search data on a user device based on estimated travel time to candidate locations.

In an exemplary scenario, a user may wish to obtain a list of points of interest (“candidate locations”) of a certain class within a given travel time of the user or another location specified by the user. The user may wish to view the list in ascending order of travel time to each candidate location.

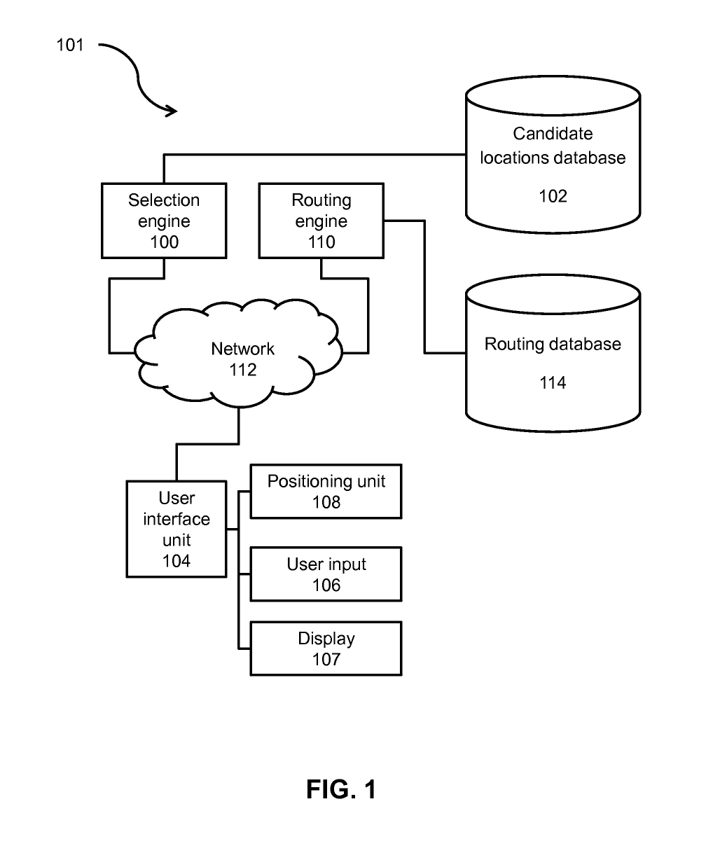

Referring now to FIG. 1, a navigational computer system 101 for presenting local search data on a user device is shown. Local search data comprises data associated with candidate locations, including the class of candidate locations, such as, for example, restaurants, offices, shopping, tourist sites, government buildings, fuelling stations, automobile repair shops, transit hubs. The navigational computer system 101 comprises: (i) a user interface unit 104 having a user input 106, a display 107 and a positioning unit 108; a selection engine 100 in communication with the user interface unit 104; a candidate locations database 102 storing local search data associated with candidate locations, and in communication with the selection engine 100; a routing engine 110 in communication with the user interface unit 104 and/or the selection engine 100; and a routing database 114 storing dynamic and/or static routing data and in communication with the routing engine 110. The user interface unit 104 communicates with the selection engine 100 and routing engine 110 over a network 112, such as, for example, the Internet, an intranet or other network.

The user interface unit 104 is a computing device which may be embodied as a smartphone, tablet or other mobile or dedicated navigational computing device. The user input 106 of the user interface unit 104 receives inputs from the user of the user interface unit 104. The user input 106 may be a touchscreen, keyboard, mouse, microphone or other user suitable user input components. The display 107 may be a touchscreen (in which case the display 107 and user input 106 may be provided by the same touchscreen), computer monitor or other suitable display.

The positioning unit 108 may be a GPS or other system configured to provide positioning information for the user interface unit 104 according to a suitable positioning technique, such as, for example, GPS, triangulation of Wi-Fi, known Wi-Fi access points or IP to location mapping. Positioning information may comprise a location and a movement vector for the user interface unit 104. The navigational computer system 101 may use the positioning information to obtain a starting location and actual locations of the user interface unit 104 for routing. As an alternative to the positioning unit 108, a user may manually enter her location, such as, for example, in cases where the user interface unit 104 does not have a positioning unit 108, or where the positioning unit 108 cannot provide positioning information.

Although FIG. 1 illustrates the user interface unit 104 being in communication with the selection engine 100 and the routing engine 110 over the network 112, the user interface unit 104 may comprise either or both of the selection engine 100 and the routing engine 110. Similarly, the candidate locations database 102 and the routing database 114 may be databases on the user interface unit 104, such that some or all functions provided by the navigational computer system 101 may be performed onboard the user interface unit 104.

The local search data stored in the candidate locations database 102 comprises candidate locations and their associated class and location data, such as, for example, geographical coordinates, mapping and overlaying. The candidate locations database 102 may further comprise routing information. Routing information may comprise, for example, roads, highways, railways, walking trails, etc. (hereinafter referred to as routes) for the geographical area. Routing information may further comprise, for example, actual traffic conditions, anticipated, actual, and/or average travel speeds for various transportation modes, surface conditions, weather patterns and other factors influencing travel along the routes. Routing information may be stored, alternatively or additionally, in the routing database 114. The selection engine 100 and/or the routing engine 110 may access the routing database 114 to determine one or more routes and estimated travel times between a starting location and the candidate locations.

After the user enters a search query for a class of candidate locations, as described below in further detail, the selection engine 100 identifies the candidate locations belonging to that class from the candidate locations database 102. The search query may further define additional search parameters, whether based on user selection or on default search parameters. The selection engine 100 then generates a list of the identified candidate locations for presentation to the user on the display 107.

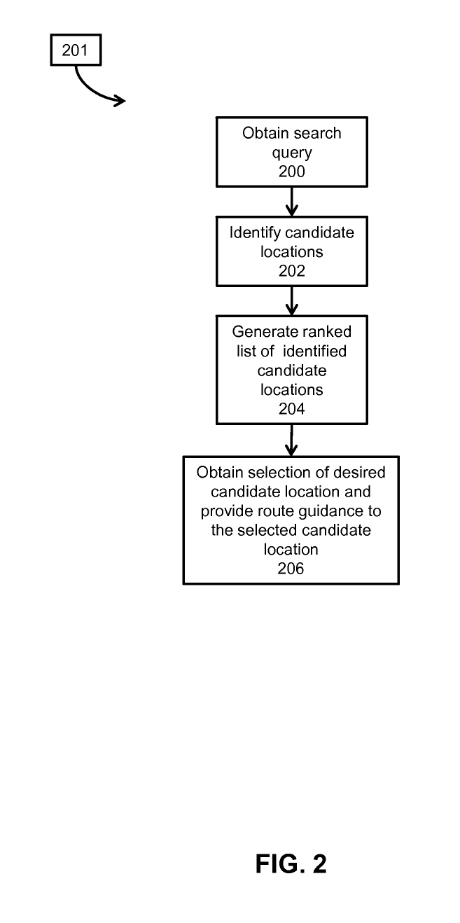

Referring now to FIG. 2, a block diagram illustrates a navigational computer method 201 for presenting local search data according to travel times to local search results. The navigational computer method 201 enables a user of a user interface unit 104 to request a list of candidate locations of a selected class for ranked presentation on a display 107 of the user interface unit 104 according to travel times to the candidate locations.

At block 200, the selection engine 100 obtains a search query from the user interface unit 104 for a list of candidate locations from a selected class. The search query may further define search parameters comprising, for example, a starting location from which travel times to the candidate locations are to be determined, an upper travel time limit, a mode of transportation, and other parameters. The class is selected by the user and the search parameters may be selected or provided by the user of the user interface unit 104 via the user input 106, as well as by other components of the user interface unit 104, including the positioning unit 108. For example, in addition to the class of candidate locations to search, the search query may define search parameters such as a maximum travel time or distance the user is willing to travel to the candidate locations from the class.

In an exemplary scenario, a user may select the class “restaurants” and the search parameter “within 15′ minutes' walking distance of the starting location” to generate a search query to return “restaurants” within 15 minutes' walking distance of a starting location.

The starting location may be the user's present location (i.e., location at the time of submitting the search query) or another starting location selected by the user. If the user interface unit 104 comprises a positioning unit 108, then the user's present location may be determined from positioning information provided by the positioning unit 108. Otherwise, the user may manually enter his present location or other starting location through the user input 106.

The search parameters may comprise the user's mode of transportation or desired mode of transportation, such as, for example, walking, driving or public transit. The user may select the mode of transportation during selection of the search parameters for the search query, or the selection engine 100 may infer the user's mode of transportation from the user's actual trajectory as determined from position information provided by the positioning unit 108. For example, if the selection engine 100 determines that the user's trajectory is along a rail route, the selection engine 100 may infer that the user is travelling by rail. Alternatively, if the user's trajectory is along a roadway at the same speed as traffic along that roadway, the selection engine 100 may infer that the user is travelling by car. If the mode of transportation cannot be determined, the selection engine 100, which may be in communication with a memory having default parameters stored thereon, may retrieve the default parameters from the memory whenever the user has not selected those parameters.

The search parameters may comprise a bounding area defined by the user, for example by tracing the bounding area on a map shown on the display 107, by selecting a maximum radius from the starting location, or by selecting a plurality of bounding points around the starting location on a map.

At block 202, the selection engine 100 identifies all candidate locations from the selected class which match the search parameters (if any are defined in the search query) in the candidate locations database 102. If the selection engine 100 cannot identify any candidate locations matching the class and search parameters, the selection engine 100 may identify candidate locations which most closely match the class and/or search parameters.

In the candidate locations database 102, each candidate location may be defined by a record containing at least geographical coordinates for the candidate location, as well as the class for the candidate location. However, upon determining a starting location for a search query, the selection engine 100 may call the routing engine 110 to generate estimated travel times from the starting location to each candidate location in the candidate locations database 102. The routing engine may invoke suitable estimation techniques to estimate travel times, as hereinafter described in greater detail. The selection engine 100 may then populate the record for each candidate location with its associated estimated travel time as determined by the routing engine 110. The selection engine 100 may then search the candidate locations database 102 for all records from the selected class and with a travel time that is less than the upper travel time limit specified in the search query if one is specified. If the search query defines additional parameters, the selection engine 100 also searches the records for compliance with the additional search parameters and selects the candidate locations from the selected class whose records comply with all parameters of the search query, or the next most compliant candidate locations if no candidate locations match all the parameters.

Alternatively, if the search query defines an upper limit in terms of estimated travel time, but the selection engine 100 does not populate the records for the candidate locations with travel times, as previously described, the selection engine 100 may instead call the routing engine 110 to return a boundary defining a geographical region lying within the upper travel time limit for the search query. The selection engine 100 then searches the records for all matching candidate locations situated within the boundary returned by the routing engine 110. If, instead, the user defines a bounding area when selecting the parameters for the search query, the selection engine 100 may use that bounding area to search the records in the same manner.

At block 204 the selection engine 100 generates a ranked list of identified candidate locations, once the selection engine 100 has identified candidate locations for a search query. The selection engine 100 provides the ranked list to the user interface unit 104 for presentation on the display 107. The selection engine 100 ranks the identified candidate locations according to estimated travel times to each candidate location. Ranking according to travel times may correspond to several approaches: (i) a ranking according to earliest estimated time of arrival (ETA) for the user at each identified candidate location; (ii) a ranking according to least travel time from the starting location to each identified candidate location; (iii) a ranking according to least time in traffic en route to each identified candidate location; or (iv) a ranking according to latest departure time from the starting location to arrive at each identified candidate location by a given ETA. The selection engine 100 may apply the approach by default, or according to user preference as selected by the user during generation of the search query at block 200.

The selection engine 100 may call the routing engine 110 to calculate estimated travel times based on predicted or actual factors. The routing engine 110 may incorporate the user's real time location and movement vector into the calculation of estimated travel times, as previously described. The routing engine may calculate estimated travel times based on one or more of the following parameters: the user's mode of transportation, which may be provided by the user or deduced from the user's motion as detected by one or more motion co-processors in the user device; the user's location; the user's real-time location and movement vector; traffic conditions; and weather conditions.

In addition to ranking identified candidate locations according to travel times, the selection engine 100 may consider ranking parameters, such as, for example, route or candidate location proximity to other nearby amenities, such as, for example, proximity of each identified candidate location to parking (such as when the user wishes to minimize time afoot due to bad weather), proximity to public transportation, route proximity to fuelling stations, route proximity to gas stations with least gas price. Ranking parameters may also comprise a preference to minimize time in transit while walking to an identified candidate location.

Ranking parameters may further comprise other parameters relating to routing, such as, for example, fuel consumption between locations, or other parameters specific to the user's vehicle or mode of transportation. Ranking parameters may comprise routing to avoid specific area, such as, for example, areas that are anticipated to be congested due to sporting events, or known crime afflicted areas. Still further, the ranking parameters may comprise cumulative traffic time which includes pre-specified times for arrival at a set of way points.

The ranking parameters may comprise the travel time of other people (i.e., users using user interface units 104) to the candidate locations. It will be appreciated that the travel time for the other people may be determined in the same manner as the user's travel time, as described above, including, for example, according to traffic conditions encountered or likely to be encountered by the other people. In an exemplary scenario, a user wishing to arrange a lunch meeting with colleagues may enter coordinates (for example, a unique identifier, a social network identifier, or position coordinates representing a starting location for those colleagues) for those colleagues while selecting parameters for the search query. The selection engine 100 may then identify position coordinates for those colleagues and rank the candidate locations by, for example, preferring highest correlation between the ETAs for the user and her colleagues, or least combined travel time for the user and his colleagues.

The user interface unit 104 receives the ranked list of identified candidate locations from the selection engine 100 and displays the ranked list to the user on the display 107. The ranked list may be presented, for example, as a series of icons, as pinpoints on a map, as a text list or in other suitable arrangement. Using the user input 106, the user may select one of the identified candidate locations. For example, if the user input 106 and display 107 are combined as a touchscreen and the ranked list is displayed as a series of icons, the user may touch one of the icons to select route guidance to the selected candidate location represented by that icon. The selection engine 100 may further re-rank the identified candidate locations upon request from the user to, for example, prefer or omit one or more of the ranking parameters. In aspects, the present navigational computer system and method may enable the user to identify and navigate to candidate locations according to estimated travel times to the identified candidate locations.

At block 206, the selection engine 100 receives the selection from the user interface unit 104 and recognises the selection as a request for route guidance to the selected candidate location. Route guidance is defined by routing information between the starting location and the selected candidate location.

If the selection engine 100 has obtained sufficient routing information from the routing engine 110 at the candidate locations identification stage (block 202) and/or the candidate locations ranking stage (block 204), and if the selection engine 100 has stored the routing information in memory or storage, such as, for example, the candidate locations database 102, the selection engine 100 may retrieve the routing information and provide it to the user interface unit 104 for providing route guidance to the selected candidate location. Otherwise, the selection engine 100 may call the routing engine 110 to generate the requested routing information. The routing engine 110 may provide the routing information directly to the user interface unit 104, or it may provide the routing information to the selection engine 100 for onward provision to the user interface unit 104.

The routing engine 110 may provide static routing information, i.e., by performing a single determination of a route between the starting location and the selected candidate location, or dynamic routing information, i.e., by continuously updating the routing information according to changes to the user's position or to other factors affecting the user's travel time along potential routes from the user's position to the selected candidate location.

In certain cases, when an individual conducts a location-based search, distance may not be the most determinative factor in terms of practical accessibility. In one exemplary scenario, a user located in Manhattan may wish to find nearby locations, such as restaurants, in the user's vicinity. Given a set of results for a search, some results, although closer to the user in terms of distance, might require much longer travel times than other results which are further from the user. For example, travel to some nearby results could require the user to travel over a heavily congested bridge as opposed to driving to a result which is further away from the user's starting location, but which is within the island of Manhattan.

Although the invention has been described with reference to certain specific embodiments, various modifications thereof will be apparent to those skilled in the art without departing from the spirit and scope of the invention as outlined in the claims appended hereto. The entire disclosures of all references recited above are incorporated herein by reference.

What is claimed is:

1. A navigational computer method for presenting local search data to a user using a user interface unit, the method comprising:
a selection engine obtaining from the user interface unit a search query for a class of candidate locations;
the selection engine identifying in a candidate locations database a plurality of candidate locations from the class;
the selection engine requesting and obtaining from a routing engine an estimated travel time for the user to each of the identified plurality of candidate locations from a starting location;
the selection engine ranking the identified plurality of candidate locations according to the estimated travel time to each of the identified plurality of candidate locations; and
the selection engine providing to the user interface unit a list of the identified plurality of candidate locations ordered according to the ranking.

2. The navigational computer method of claim 1, further comprising:
upon the selection engine receiving from the user interface unit a selection of one candidate location from the identified plurality of candidate locations, the selection engine causing route guidance from the starting location to the selected candidate location to be provided to the user interface unit.

3. The navigational computer method of claim 1, the selection engine further ranking the identified plurality of candidate locations according to ranking parameters.

4. The navigational computer method of claim 3, wherein the search query defines search parameters, and the selection engine defines the ranking parameters based on the search parameters.

5. The navigational computer method of claim 3, wherein the selection engine defines the ranking parameters based on default ranking parameters.

6. The navigational computer method of claim 3, wherein the ranking parameters comprise proximity of amenities to each of the identified plurality of candidate locations, or proximity of amenities to a route from the starting location to each of the identified plurality of candidate locations.

7. The navigational computer method of claim 3, wherein the ranking parameters comprise the travel time to each of the identified plurality of candidate locations from a starting location for each of other users.

8. The navigational computer method of claim 1, wherein the selection engine defines the starting location based on position information obtained from a positioning system of the user interface unit.

9. The navigational computer method of claim 2, wherein the route ranking according to the estimated travel time comprises the selection engine ranking according to an estimated time of arrival of the user at each of the identified plurality of candidate locations.

10. The navigational computer method of claim 2, wherein the route guidance is dynamic.

11. A navigational computer system for presenting local search data to a user using a user interface unit, the system comprising:
a candidate locations database storing a plurality of candidate locations; and
a selection engine in communication with the candidate locations database, a routing engine and a user interface unit, the selection engine being configured to:
obtain from the user interface unit a search query for a class of candidate locations;
identify in the candidate locations database a plurality of candidate locations belonging to the class;
request and obtain from the routing engine an estimated travel time for the user from a starting location to each of the identified plurality of candidate locations belonging to the class;
rank the identified plurality of candidate locations according to the estimated travel time to each of the identified plurality of candidate locations; and
provide to the user interface unit a list of the identified plurality of candidate locations ordered according to the ranking.

12. The navigational computer system of claim 11, wherein the selection engine is further configured to:
receive from the user interface unit a selection of one of the identified plurality of candidate locations; and
upon receiving the selection, cause route guidance from the starting location to the selected candidate location to be provided to the user interface unit.

13. The navigational computer system of claim 11, wherein the selection engine is further configured to rank the identified plurality of candidate locations according to ranking parameters.

14. The navigational computer system of claim 13, wherein the search query defines search parameters and the selection engine is configured to define the ranking parameters based on the search parameters.

15. The navigational computer system of claim 13, wherein the selection engine is further in communication with storage storing default ranking parameters, and wherein the selection engine is configured to define the ranking parameters based on the default ranking parameters.

16. The navigational computer system of claim 13, wherein the ranking parameters comprise proximity to amenities of each of the identified plurality of candidate locations or to a route to each of the identified plurality of candidate locations.

17. The navigational computer system of claim 13, wherein the ranking parameters comprise a travel time to each of the identified plurality of candidate locations from a starting location for each of other users.

18. The navigational computer system of claim 11, wherein the selection engine is further configured to obtain positioning information from a positioning system of the user interface unit, and to define the starting location based on the positioning information from the positioning system.

19. The navigational computer system of claim 12, wherein the selection engine is configured to rank according to travel time by ranking according to an estimated time of arrival of the user at each of the identified plurality of candidate locations.

20. The navigational computer system of claim 12, wherein the route guidance is dynamic.
